(19) United States
(12) Patent Application Publication
(10) Pub. No.: US 2025/0071602 A1
(43) Pub. Date: Feb. 27, 2025

(54) TID-BASED COMMUNICATION METHODS USING STREAM CLASSIFICATION SERVICES FOR LATENCY SENSITIVE STREAM AND MULTILINK APPARATUS

(71) Applicant: CANON KABUSHIKI KAISHA, Tokyo (JP)

(72) Inventors: PASCAL VIGER, JANZE (FR); STÉPHANE BARON, LE RHEU (FR); PATRICE NEZOU, LIFFRE (FR)

(21) Appl. No.: 18/721,135

(22) PCT Filed: Dec. 16, 2022
(86) PCT No.: PCT/EP2022/086451

§ 371 Date: Jun. 17, 2024

(30) Foreign Application Priority Data
Dec. 17, 2021 (GB) 2118470.0

(51) Int. Cl. H04W 28/02; H04W 72/566; H04W 84/12

(52) U.S. Cl. CPC H04W 28/0263; H04W 28/0268; H04W 72/566; H04W 84/12

(57) ABSTRACT

To easy the triggering by an AP MLD of uplink communications of low latency streams from non-AP MLD, the invention proposes that a local traffic stream be identified using a Stream Classification Service, SCS. The local SCS traffic stream is mapped onto a target TID which was previously mapped with an impacted UP. The local SCS stream is preferably assigned to an alternate queue of an AC. Said impacted UP is also mapped onto a fallback TID, corresponding to the primary queue of the same AC. The SCS stream is advertised to the AP using a SCS Request frame. Conventional fields can be used. A trigger frame from an affiliated AP of the AP MLD may then provide resource units to an affiliated non-AP station dedicated to the target TID, hence specific to the low latency SCS stream.

### CROSS-REFERENCE TO RELATED APPLICATIONS

This application is the National Phase entry of PCT Application No. PCT/EP2022/086451 filed on Dec. 16, 2022, which claims the benefit under 35 U.S.C. § 119(a)-(d) of United Kingdom Patent Application No. 2118470.0, filed on Dec. 17, 2021 and entitled “TID-BASED COMMUNICATION METHODS USING STREAM CLASSIFICATION SERVICES FOR LATENCY SENSITIVE STREAM AND MULTILINK APPARATUS”.

The above cited patent applications are incorporated herein by reference in their entireties.

### FIELD OF THE INVENTION

The present invention generally relates to wireless communications and more specifically to Multi-Link (ML) communication.

### BACKGROUND OF INVENTION

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

Low latency reliable services, LLRS, have been defined as targets of such main objective. LLRSs are services provided to a higher layer traffic stream that prioritize and deliver MSDUs (data units) within a worst-case latency budget with a given reliability/packet delivery ratio (PDR) and low jitter.

The IEEE P802.11be/D1.3 version (November 2021, below the “D1.3 standard”) introduces the Multi-link (ML) operation (MLO). MLO improves data throughput by allowing communications between stations over multiple concurrent and non-contiguous communication links.

Multi-Link Operation enables a non-AP (access point) MLD (ML device) to register with an AP MLD, i.e. to discover, authenticate, associate and set up multiple links with the AP MLD. Each link enables channel access and frame exchanges between the non-AP MLD and the AP MLD based on supported capabilities exchanged during association.

A MLD is a logical entity that has more than one affiliated station (AP or non-AP) and has a single medium access control (MAC) service access point (SAP) to logical link control (LLC), which includes one MAC data service. An AP MLD is thus made of multiple affiliated APs whereas a non-AP MLD is made of multiple affiliated non-AP stations. The affiliated stations in both AP MLD and non-AP-MLD can use 802.11 mechanisms to communicate with affiliated stations of another MLD over each of the multiple communication links that are set up.

During ML discovery, a non-AP MLD discovers the various wireless links available by the AP MLD through its various affiliated APs. The non-AP MLD builds a set of candidate links associating affiliated APs with affiliated non-AP stations, from the discovered links (affiliated APs). During ML setup, the non-AP MLD, in collaboration with the AP MLD, setups links to be used for data exchange between the non-AP MLD and the AP MLD.

To meet low latency requirements in EHT as well as to increase efficiency of the UL MU operation, the Stream Classification Service (SCS) mechanism, originally defined in the IEEE/802.11aa standard, has been included in the D1.3 standard with some adaptations. The SCS mechanism for multi-link allows a non-AP MLD to define and advertise the AP MLD of a local traffic stream identified with an SCS identifier, SCSID.

Co-pending application GB 2108299.5 provides an extended usage of the SCSID identifier, in both Trigger frame (for UL MU operation) and Service Periods (e.g. target wake time periods, TWT) dedicated to low latency flow delivery. A local traffic stream with an SCSID can be defined for a low latency flow and advertised to the AP MLD. Next, the AP MLD may allocate resources specific for one or more of those low latency traffic streams, based on the received advertisement.

The proposed solution is however not fully satisfactory.

Dedicated behaviors are required at the non-AP stations to finely separate low latency data (forming SCS traffic streams) from normal data belonging to the same traffic class, i.e. having the same traffic identifier (TID) priority. For example, a specific labelling of the data in the AC queues can be implemented. Low-end stations may not be adapted to such additional processes.

In addition, with triggered UL MU operations or service periods dedicated to a SCS low latency traffic stream, normal data having the same TID in the AC queue are not transmitted, thereby raising an issue about the management of the sequence numbering for block acknowledgment by the AP. In particular, head-of-line blocking may occur.

### SUMMARY OF THE INVENTION

It is a broad objective of the present invention to overcome some of the foregoing concerns. Improved SCS mechanisms may be used to allow a non-AP MLD to reserve a local TID queue associated with low latency streams.

The invention relates to a communication method in a wireless network, that comprises at a non-access point, AP, multi-link device, MLD:
performing communication with an AP MLD based on traffic identifiers, TIDs. Communications may relate to triggered UL MU operations or service periods or the like that for example directly target a specific TID or another class (e.g. an access category) corresponding to the TID.

According to the invention, the method at the non-AP MLD further comprises:
identifying a local traffic stream using a Stream Classification Service, SCS,
mapping the local traffic stream onto a target TID previously mapped with an impacted user priority and mapping the impacted user priority, UP, onto a fallback TID. The fallback TID is separate from the target TID.

The mappings may be temporary as long as said SCS local traffic stream is being generated. Data having the impacted UP are therefore remapped from the target TID (initial mapping) to the fallback TID. This concerns both the data already stored in the queue identifying by the target TID and the new data arriving at the classifier mapping the data to the ACs.

In the invention, a specific TID, target TID, is dedicated to the local SCS stream. Communication of this specific SCS stream with the AP MLD can then be conducted using the specific target TID, while the conventional UPs are still mapped onto other TIDs for appropriate communication. In particular, the AP MLD can then use the target TID to easily trigger uplink communication from a non-AP MLD, that is dedicated to the local SCS stream only.

Advantageously, the invention avoids sequence numbering issues and additional mechanisms to discriminate the local SCS stream within the stored data having said target TID. Low latency traffic management can therefore be implemented in low-end devices.

In addition, with the invention, each registered non-AP MLD can individually declare its local SCS stream on demand (i.e. only when needed), and accordingly adjust the TID-to-UP mapping with the AP MLD. There is no need to provide an overall remapping that impacts all the non-AP MLDs of the wireless network.

From AP MLD perspective, a communication method in a wireless network, comprises at an access point, AP, multi-link device, MLD:
performing communication with one or more non-AP MLDs based on traffic identifiers, TIDs.

According to the invention, the method at the AP MLD further comprises:
receiving, from a non-AP MLD, a Stream Classification Service, SCS, request frame adding a traffic stream local to the non-AP MLD,
responsive to the receiving, mapping the local traffic stream onto a target TID previously mapped with an impacted user priority and mapping the impacted user priority, UP, onto a fallback TID. These mappings apply for the communications with that non-AP MLD only, and not for the entire BSS. The AP MLD as a gateway to other networks now uses the mapping to correctly forward SCS data (if any) over the target TID and data having the impacted UP over the fallback TID.

In some embodiments, the method at the non-AP MLD further comprises sending, to the AP MLD, a Stream Classification Service, SCS, request frame adding the local traffic stream. This allows the AP MLD to correspondingly configure itself with the new mapping. The request may specify the target TID that is to be used for the mapping, or may merely specify an access category (usually made of two TIDs) and whether a primary queue (i.e. TID) or an alternate queue (i.e. a separate TID) is to be used.

In some embodiments, the SCS request frame includes an SCS identifier of the local traffic stream and signals the target TID onto which the local traffic stream is mapped and/or the impacted UP with which the target TID was previously mapped.

In some embodiments, the SCS request frame includes a SCS descriptor, wherein the SCS descriptor:
identifies the local traffic stream using a SCS identifier, SCSID,
signals the target TID and/or the impacted UP, and
includes an Alternate Queue field in an Intra-AC Priority Element according to IEEE P802.11be/D1.3, wherein the Alternate Queue field specifies whether a primary queue or an alternate queue in the same access category is dedicated to store the local traffic stream. This is advantageously compliant with the conventional format of the SCS descriptor, with the Intra-AC Priority Element becoming mandatory for the signaling of the present invention.

In embodiments, the access category includes a queue identified by the target TID or impacted UP. For example, where the target TID or corresponding impacted UP is 4, the AC is video (VI) that manages a queue with TID=4 and a queue with TID=5.

In other embodiments, the target TID is signaled in a TID field provided in a Control Info field of a QoS Characteristics Element according to IEEE P802.11be/D1.3 within the SCS descriptor, and/or the impacted UP is signaled in a User Priority field provided in the Alternate Queue field.

In some embodiments, the target TID identifies an alternate queue of a pair of primary and alternate queues forming an 802.11 access category. The queues are implemented at MAC (medium access control) level.

In embodiments, the fallback TID identifies the primary queue. This ensures the data having the impacted UP are still transmitted using the same EDCA parameter (through the corresponding AC), hence they keep the same level of priority.

In some embodiments, mapping the impacted UP to the fallback TID includes moving data having the impacted UP from a queue identified by the target TID to another queue identified by the fallback TID, wherein a sequence number of the data is adapted (updated) to the other queue when moved to that other queue. The same may apply at the AP MLD.

The sequence number (SN) update seeks to keep SN continuity within each TID, i.e. throughout all data corresponding to the impacted UP and the UP already mapped onto the fallback TID. As an example, when UP=4 is mapped to TID=5, data in queue identified by TID=4 are moved to queue identified by TID=5, and their SNs are modified to provide continuity with the SNs of data already in queue identified by TID=5.

In some embodiments, the method further comprises sending, to the AP MLD, or receiving, from the non-AP MLD, a SCS request frame removing the local traffic stream, and, responsive to the receiving, unmapping the local traffic stream from the target TID.

The target TID therefore becomes available to be used for another SCS stream, in which case a new SCS request frame adding a new local traffic stream is sent to be mapped onto the target TID.

The target TID also becomes available to receive back data having the impacted UP that are currently stored in the fallback queue. In that case, the method may further comprise mapping back the impacted UP onto the target TID. The sequence numbering of the data moved back to the corresponding queue may also be updated.

A control on whether the data having the impacted UP have to be mapped back to the target UP or not may be implemented at the non-AP MLD. For example, the removing SCS request frame may signal whether the impacted UP is to be mapped back onto the target TID or not. For example, such signaling is conveyed in an Alternate Queue field of an Intra-AC Priority Element of an SCS descriptor according to IEEE P802.11be/D1.3 within the removing SCS request frame.

The invention also regards a communication method in a wireless network, comprising at a non-access point, AP, multi-link device, MLD:
sending, to an AP MLD, a Stream Classification Service, SCS, request frame, the SCS request frame containing an Intra-Access Category Priority Element and a QoS characteristics Element,
wherein a User Priority subfield contained in the Intra-Access Category Priority Element and a User Priority subfield contained in the QoS characteristics Element are set to a same value.

The invention also regards a Stream Classification Service, SCS, request frame for communication in a wireless network, the SCS request frame containing an Intra-Access Category Priority Element and a QoS characteristics Element, wherein a User Priority subfield contained in the Intra-Access Category Priority element and a User Priority subfield contained in the QoS characteristics Element are set to a same value.

Correlatively, the invention also provides a wireless communication device comprising at least one microprocessor configured for carrying out the steps of any of the above methods. The wireless communication device may be either of a non-AP MLD and an AP MLD.

The wireless communication device further comprises one or more access categories, ACs, having one primary queue and one alternate queue. The target TID onto which the local traffic stream is mapped identifies the alternate queue of an AC, whereas the fallback TID identifies the primary queue of that AC.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates an example of a multi-link arrangement in accordance with 802.11 be;

FIG. 2a illustrates an example of a reference model of an 802.11be multi-link device;

FIG. 2b illustrates the IEEE 802.11e EDCA involving four Access Categories, when deployed over multiple links;

FIG. 2b illustrates an example of mapping between eight priorities of traffic class and the four EDCA ACs;

FIG. 3 illustrates a QoS Map element according to IEEE 802.11be D1.3;

FIGS. 4a and 4b illustrates the Stream Classification Service mechanisms as proposed in the IEEE 802.11be D1.3;

FIGS. 5 and 6 illustrate, using flowcharts, exemplary methods at respectively a non-AP MLD and an AP MLD, according to embodiments of the invention;

FIG. 7 illustrates a modified SCS Descriptor according to embodiments of the invention;

FIG. 8 illustrates an architectural concept of inter-queue priority mapping according to embodiments of the invention;

FIG. 9 illustrates, using flowchart, exemplary embodiments of the invention implemented at a QoS classifier entity of a non-AP MLD;

FIG. 10a, 10b illustrate exemplary mapping between eight priorities of traffic class and various SCS streams towards the eight EDCA ACs; and

FIGS. 11a, and 11b illustrate multi-link communication device hardware and software architecture according to at least one embodiment of the present invention.

### DETAILED DESCRIPTION OF THE INVENTION

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to transmit simultaneously data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

Note that it is not excluded that an apparatus may act as an AP of one wireless network and at the same time may belong to another (neighboring) wireless network as a STA. This may occur in the context of Multi-AP technology, which consists in enabling some degree of collaboration among neighboring APs in order to have a more efficient utilization of the limited time, frequency and spatial resources available. With such a technology, two neighboring APs may share resources in terms of frequency or time and, in this way, prevents interferences. APs that collaborate to share resources are referred to as coordinated APs. Moreover, the data transmission established by coordinated APs is referred as Multi-AP transmission.

While the examples are described in the context of WiFi® networks, the invention may be used in any type of wireless networks like, for example, mobile phone cellular networks that implement very similar mechanisms.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification, BSSID and managed by a separate virtual AP implemented in the physical AP.

The 802.11 family of standards define various media access control (MAC) mechanisms to drive access to the wireless medium.

The current discussions in the task group 802.11be, as illustrated by draft IEEE P802.11be/D1.3 of November 2021, introduce the Multi-Link Operation (MLO) when it comes to MAC layer operation. The MLO allows multi-link devices to establish or setup multiple links and operate them simultaneously.

A multi-link device (MLD) is a logical entity and has more than one affiliated (AP or non-AP) station (STA) and has a single medium access control (MAC) service access point (SAP) to logical link control (LLC), which includes one MAC data service. Besides, the MLD also comprises a single address associated with the interface, which can be used to communicate on the distribution system medium (DSM).

The stations forming the same MLD may be partly or all collocated within the same device or geographically dispersed.

An access point multi-link device (AP MLD) corresponds to a MLD where each station (STA) affiliated with the MLD is an AP, referred to as “affiliated AP” hereinafter.

A non-access point multi-link device (non-AP MLD) corresponds to a MLD where each station (STA) affiliated with the MLD is a non-AP station, referred to as “affiliated non-AP station”.

When referring hereinafter to either an AP MLD or a non-AP MLD, the general term “station MLD” may be used.

Depending on the literature, “multilink device”, “ML device” (MLD), “multilink logical entity”, “ML logical entity” (MLE), “multilink set” and “ML set” are synonyms to designate the same type of ML device.

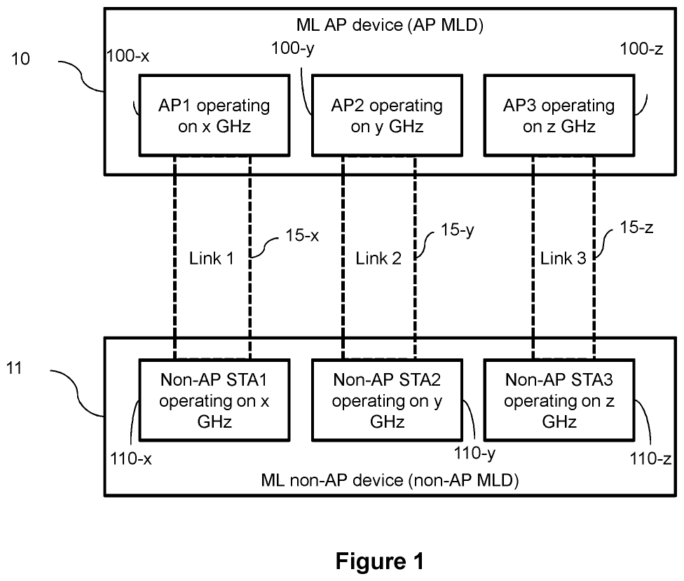

An example of two MLDs, an AP MLD 10 and a non-AP MLD 11 establishing a multilink communication session to exchange data units, in accordance with 802.11be is illustrated in FIG. 1.

As visible, the AP MLD 10 comprises three affiliated APs 100-x, 100-y, and 100-z and the non-AP MLD 11 comprises three affiliated non-AP STAs 110-x, 110-y and 110-z. Although illustrated MLDs are made of three affiliated non-AP stations or APs, MLDs with another number of affiliated non-AP stations or APs may be contemplated with the same teachings.

Each station 100-x, 110-x, 100-y, 110-y, 100-z, or 110-z is a logical entity that is a singly addressable instance of a medium access control (MAC) and physical layer (PHY) interface to the wireless medium.

Multiple affiliated non-AP stations of a non-AP MLD may then setup communication links with multiple affiliated APs of an AP MLD, hence forming a multi-link channel.

As visible in FIG. 1, the communication links 15-x, 15-y, 15-z are physical paths usable to transfer MAC service data units (MSDUs) between an affiliated non-AP station and an affiliated AP. Thus, the communication link 15-x is the communication channel established between the AP 100-x and the non-AP STA 110-x. Similarly, the communication links 15-y and 15-z corresponds to the communication channels established between respectively the AP 100-y and the non-AP STA 110-y, and the AP 100-z and the non-AP STA 110-z.

A communication link or “link” thus corresponds to a given channel (e.g. 20 MHz, 40 MHz, and so on) in a given frequency band (e.g. 2.4 GHz, 5 GHz, 6 GHz) between an AP 100-x, 100-y, 100-y affiliated with the AP MLD 10 and a non-AP STA 110-x, 110-y, 110-z affiliated with the non-AP MLD 11.

As visible on FIG. 1, the AP 100-x and the non-AP STA 110-x, the AP 100-y and the non-AP STA 110-y, and the AP 100-z and the non-AP STA 110-z respectively operates on the following frequency bands, x GHz, y GHz and z GHz. These frequency bands may be different one from the other such that the corresponding communication links 15-x, 15-y, 15-z belong to the respective frequency bands, x GHz, y GHz and z GHz. Alternatively, the links may belong to the same frequency band, i.e. the STAs may use a same frequency band.

Preferably, the links established for MLDs are considered as fully independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

The affiliated APs and non-AP stations may operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can be transmitted across multiple parallel communication links, thereby increasing network capacity and maximizing utilization of available resources.

The terms “traffic” and/or “traffic stream(s)” as used herein, are defined as a data flow and/or stream between wireless devices.

Although FIG. 1 shows a ML AP device and a ML non-AP device establishing a ML communication session, two non-AP MLDs may also establish such a ML communication session for DirectLink (or peer-to-peer) communication.

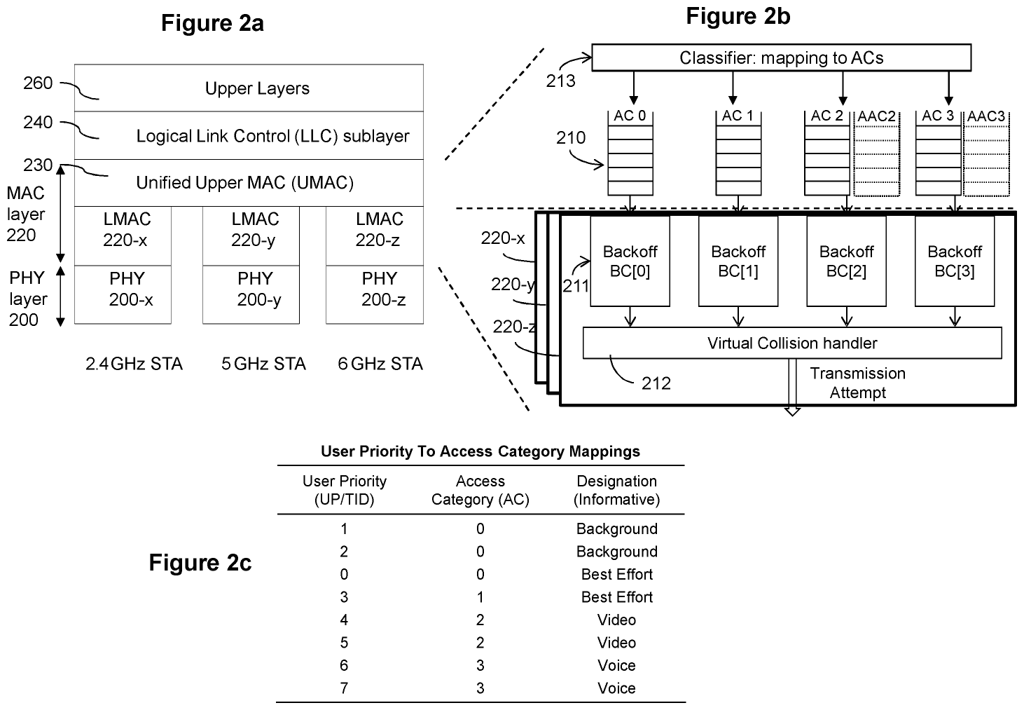

FIG. 2a illustrates an exemplary 802.11be multi-link reference model for a MLD either AP MLD (e.g. as AP MLD 10 of FIG. 1) or non-AP MLD (e.g. as non-AP MLD 11 of FIG. 1).

The MLD comprises a PHY layer 200, a MAC layer 220, a logical link control (LLC) sublayer 240 and upper layers 260.

Upper layers 260 may include applications that generate traffic data or use received traffic data.

The transmission and the receiving of the traffic data are handled by the MAC 220 and PHY 200 layers. Such transmission and the receiving of the traffic data may take place over multiple links, as the one 15-x, 15-y, 15-z introduced with reference to FIG. 1.

The traffic data are provided by the upper layers as a sequence of data frames, or “traffic stream”. Each traffic stream and thus each data frame are associated with an access category (AC) as defined in the EDCA mechanism (FIG. 2b). This mapping between the streams or data frames and the ACs is made by a classifier 213.

It is recalled that an 802.11 station (AP and non-AP station) maintains four Access Categories (ACs), each having one or more corresponding transmit buffers or queues. The four ACs are conventionally defined as follows:
AC1 and AC0 are reserved for best effort and background traffic. They have, respectively, the penultimate lowest priority and the lowest priority.
AC3 and AC2 are usually reserved for real-time applications (e.g., voice or video transmission). They have, respectively, the highest priority and the penultimate highest priority.

The data frames, also known as MAC service data units (MSDUs), incoming from an upper layer of the protocol stack are mapped, by classifier 213, onto one of the four ACs and thus input in a queue of the mapped AC. The mapping is based on a traffic class of the MSDUs deduced from a so-called DSCP field (explained below) in the data units. Therefore, an 802.11 station supports a traffic prioritization similar to DiffServ (Differentiated Services), and the mapping is performed between one of the eight priorities of traffic class (also known as User Priorities, or UPs) of the incoming MSDU onto a corresponding one of the four ACs, according to a predefined mapping rules.

FIG. 2c shows an exemplary mapping between eight UPs (values between 0-7 according to IEEE 802.1d) and the four ACs. This designation is an indication of general usage and guidance, according to Table 10-1-UP-to-AC mappings of 802.11-2020 standard.

The traffic class or UP is indicated inside the MSDUs using a Traffic Identifier (TID) taking values in the range 0 to 7, often the same value as the UP. Each MSDU thus contains an indication relating to the type of data it contains, that is to say, an indication reflecting an access category or a level of priority. This mapping is conventionally managed by the AP for its whole BSS and provided to the non-APs when associating. Another mapping different from the example of FIG. 2c can be implemented.

FIG. 2b illustrates an implementation model with four transmit queues (plain lines), one per access category.

Other implementations, such as the one provided in the IEEE/802.11aa standard, add two queues in two ACs: one alternate video queue (A_VI) in the AC VI and one alternate voice queue (A_VO) in the AC VO. Each alternate queue shares the same EDCA function (EDCAF) as the other (named “primary”) transmit queue of the same AC (VI or VO). The alternate queues are schematically shown in dotted lines (AAC2 and AAC3) in FIG. 2b. In practice, the two UPs (hence two TIDs) of the same AC are associated with respectively the alternate and primary queues of that AC.

As the same EDCAF is used for both primary and alternate queues of the same AC, a scheduling function above the EDCAF implements a selection mechanism to select a MSDU from the primary queue or from the alternate queue, upon transmitting data. In particular, the queue with the higher UP is selected with a higher probability than the queue with the lower UP.

In implementations, transmit queues may be provided on a per-UP basis (versus a per-AC basis), leading to eight transmit queues forming four pairs (one per each AC) of a primary and an alternate queues (one per each UP or TID belonging to the AC).

The 802.11be multi-link reference model reflects the fact that MLDs may transmit using several links, particularly at the level of the MAC layer 220 and the PHY layer.

The MAC layer 220 comprises a Unified Upper-MAC (UMAC) layer 230. The UMAC 230 is responsible for link-agnostic MAC procedures such as sequence number assignments, MAC Protocol Data Unit (MPDU) encryption/decryption, acknowledgement score boarding procedure, etc. Sequence number assignment consists for the UMAC 230 to add an increasing sequence number to each MSDU having the same UP (hence the same TID). This helps keeping track of the order of MSDUs while allowing block acknowledgments.

Thus, each data unit, MSDU, arriving at the MAC layer 220 from an upper layer 260 (e.g. Link layer) with a type of traffic (UP hence TID) priority is mapped onto one of the ACs according to the mapping rule at the UMAC layer 230. Then, still at the UMAC layer 230, the data unit, MSDU, is provided with the next sequence number available and is stored in the queue corresponding to its TID (or UP) within the mapped AC.

As illustrated in FIG. 2b, each AC has also its own set of queue contention (EDCA and/or MU-EDCA according to IEEE 802.11 ax-2021) parameters per link (e.g. 220-x, 220-y, 220-z), and is associated with a priority value, hence defining traffics of higher or lower priority of MSDUs. Thus, there is a plurality of traffic queues for serving data traffic at different priorities for a given link. The contention window CW and the backoff value are known as being EDCA variables, and are specialized for each Link 15-x, 15-y, or 15-z illustrated on FIG. 1.

That means that each AC acts as an independent DCF contending entity on a given link, including its respective queue backoff engine 211. Thus, each queue backoff engine 211 is associated with a respective traffic queue 210 for using queue contention parameters and drawing a backoff value (from CW) to initialize a respective queue backoff counter specialized per AC and per link. The backoff counter is used to contend for access to the link 15-x (15-y, 15-z) in order to transmit data stored in the queue of the AC.

Each traffic queue 210 is associated with at least a set of respective queue backoff engines 211, one per enabled Link.

When an access to the wireless medium is granted for an AC on a link (e.g. any of 15-x, 15-y, or 15-z), MSDUs stored for that AC are transmitted to the physical (PHY) layer 200 for transmission over the link.

Due to the specialization of the EDCAF per link, structures of MAC layer and PHY layer are adapted accordingly as shown in FIG. 2a.

MAC layer 220 of the MLD comprises multiple blocks, called lower MAC (LMAC) 220-x, 220-y, 220-z for respective multiple links 15-x, 15-y, 15-z.

PHY layer 200 of the MLD comprises multiple PHY blocks 200-x, 200-y, 200-z as well, each being dedicated for respective multiple links 15-x, 15-y, 15-z.

The UMAC layer then further offers a UMAC interface with the link-specific blocks 220-x, 220-y, 220-z and provides a UMAC Service Access Point (SAP) to the LLC 240 and upper 260 layers.

Of course, the number of blocks depends on the number of links the MLD is able to manage.

In this example, LMAC layer 220-x is associated with link 15-x via PHY layer 200-x; LMAC layer 220-y is associated with link 15-y via PHY layer 200-y; and LMAC layer 220-z is associated with link 15-z via PHY layer 200-z. In other words, each link 15x/y/z may have an associated LMAC layer 200-x/y/z that performs link-specific features, such as channel, e.g. link, access.

To access the wireless medium, e.g. link 15-x, the affiliated stations (non-AP stations and AP) active on that link 15-x compete using EDCA (Enhanced Distributed Channel Access) contention, in order to be granted a transmission opportunity (TXOP). Next, during the TXOP, the affiliated station gaining access may transmit (single-user, SU) data frames over the link. It shall be noted that legacy devices (that is to say not affiliated to an MLD) may concurrently operate on any one of the links.

As an alternative to SU transmission, the affiliated stations may also use a multi-user (MU) scheme to access the wireless medium, e.g. link 15-x. In the MU scheme, a single affiliated station, e.g. AP 100-x active on link 15-x, is allowed to schedule a MU transmission, i.e. multiple simultaneous transmissions (in so-called resource units) to or from other affiliated non-AP stations active on the same link. One implementation of such MU scheme has been for example adopted in IEEE 802.11 ax amendment standard, as the Multi-User Uplink and Downlink OFDMA (MU UL and DL OFDMA) procedures. Thanks to the MU feature, an affiliated non-AP station has the opportunity to gain access to the wireless medium via two access schemes: the MU scheme and the SU scheme (through conventional EDCA).

During a MU downlink (DL) transmission on the granted communication channel, e.g. link 15-x, affiliated AP 100-x may perform multiple simultaneous elementary transmissions, over so-called resource units (RUs), to various affiliated non-AP stations. As an example, the resource units may split link 15-x of the wireless network in the frequency domain, based for instance on Orthogonal Frequency Division Multiple Access (OFDMA) technique. The assignment of the RUs to the affiliated non-AP stations is signaled at the beginning of the MU Downlink frame, by providing an association identifier (AID) of an affiliated non-AP station for each RU defined in the transmission opportunity. AID is individually obtained by each affiliated non-AP station of a non-AP MLD during the association procedure of the non-AP MLD with AP MLD. AID therefore uniquely identifies the associated MLD stations (and therefore the affiliated non-AP station of the MLD on link 15-x over which the MU frame is emitted), and may be, for example, a 16-bit value.

During a MU uplink (UL) transmission, various affiliated non-AP stations simultaneously transmit data to AP 100-x over the resource units forming link 15-x.

To control the MU UL transmissions of the affiliated non-AP stations, affiliated AP 100-x may previously send a control frame, known as a Trigger Frame (TF). The TF may be used by affiliated AP 100-x to allocate resource units to the affiliated non-AP stations of the same BSS, using their AIDs assigned to them during the association procedure to AP 100-x and/or using reserved AIDs designating a group of affiliated non-AP stations. The TF may also define the start of the MU UL transmission by the affiliated non-AP stations, the type of traffic (TID or AC) they are allowed to transmit (if any specific, otherwise it is up to the station to decide), as well as the length thereof.

A focus is now made about the QoS (Quality of Service) implemented in such wireless networks, that is based on the ACs.

Indeed, maintaining proper end-to-end QoS is an important factor when providing interworking services. This is because the external networks might employ different network-layer (Layer 3) QoS practices. For example, the use of a particular differentiated services code point (DSCP) for a given service might be different between different networks. To provide proper QoS over-the-air in the IEEE 802.11 infrastructure, a mapping from DSCP to UP for the corresponding network needs to be identified and made known to the non-AP stations.

In an IP packet, QoS marking is provided within Type-of-Service (TOS) byte in a field called DSCP.

While no explicit guidance is offered in mapping (6-Bit) Layer 3 DSCP values to (3-Bit) Layer 2 markings (such as IEEE 802.1D, 802.1p or 802.11e), a common practice in the networking industry is to map them using a default DSCP-to-UP Mapping, wherein the 3 Most Significant Bits (MSB) of the DSCP are used as the corresponding L2 markings.

Regarding 802.11, QoS capabilities are further limited with four different Access Categories (Voice, Video, Best Effort & Background) only. When a QoS-capable non-AP station/AP transmit a MSDU, a QoS control field is provided in the frame header with a TID field to classify the MSDU. 3 bits of the TID field are known as User Priority (or UP) value and determine the priority the frame get over the air. Since 802.11 has got four different traffic classes, two UP values map onto each Access Category.

The QoS Map distribution mechanism defined in IEEE 802.11-2020 section 11.22.9 provides means to communicate the mapping information from the network (from the AP) to the non-AP stations.

Enterprise networks use mapping based on application classes defined in IETF RFC 4594 and their recommendation mapping to IEEE 802.11 UPs defined in IETF RFC 8325.

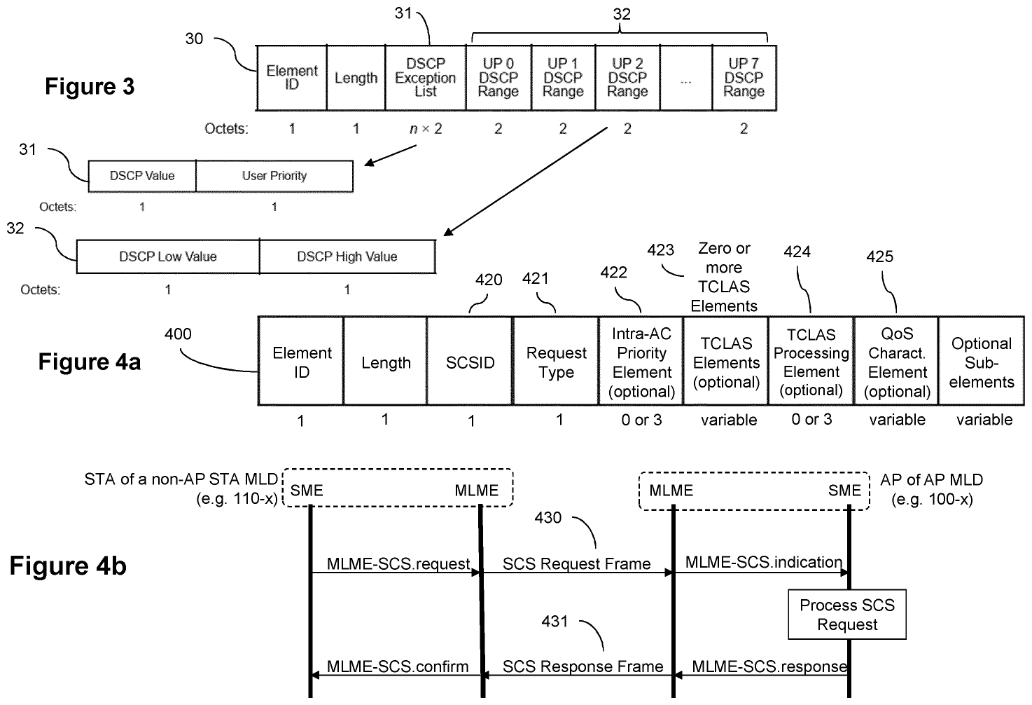

A QoS Map element 30 defining the DSCP-to-UP Mapping is shown in FIG. 3. This element is provided to the non-AP stations in the Association Response frame or Reassociation Response frame exchanged during the association procedure with the AP.

The QoS Map 30 maps the higher layer priority from the DSCP field used with the Internet Protocol to User Priority (UP).

Mapping between DSCP and UP can be done using Exception fields 31 or by range 32. To that end, the QoS Map element includes two key components:
1) a set of eight “UP×DSCP Range” fields 32 (x from 0 to 7), each field 32 defining the range of DSCP values corresponding to UP value x, and
2) a “DSCP Exception List” field 31 allowing up to 21 exceptions to be defined from these range-based DSCP-UP mapping associations. Each exception can map a specific DSCP to an UP.

The DSCP range in each field 32 is defined by a DSCP Low Value and a DSCP High Value.

The DSCP values are between 0 and 63. The DSCP range for each UP is non-overlapping the other UPs. The DSCP High Value is greater than or equal to the DSCP Low Value. If the DSCP Range High Value and Low Value are both equal to 255, it means the corresponding UP is not used.

When the AP's Management Entity detects a change in the QoS mapping information, it may update all non-AP STAs with a new QoS Map element 30. However, in practice, this update is accomplished very rarely, most of the time never during the duration of an association.

The QoS Map 30 is one exchanged information that is common to all links (15-x, 15-y, 15-z) used by the AP MLD, as the same classification applies over the links. This means the QoS mapping is managed at MLD level. Therefore, a modification of the QoS Map is no longer realistic, as maintaining proper end-to-end QoS is an important factor when providing interworking service.

The QoS information exchanged between the AP and the non-AP stations also includes the EDCA parameters driving the backoff mechanisms of FIG. 2b. In a ML architecture, the AP MLD provides such EDCA parameters in Beacon frames as well as in all Probe Response and (Re)Association Response frames. EDCA parameters are specified within a so-called EDCA Parameter Set element. The AP may change the EDCA parameters over time by changing the EDCA Parameter Set element in the Beacon frame, Probe Response frame and (Re)Association Response frame. However, in practice, the AP changes them only rarely. The EDCA parameters is one information that is specific to each AC and is local to a given Link 15-x (15-y, 15-z) where the BSS is running.

Once a multi-link association is established between a non-AP MLD and an AP MLD wherein the QoS Map 30 and the EDCA parameters have been provided, a multi-link communication can be setup over the links.

The MSDUs may then be transmitted over the multiple links, for instance using MPDU aggregation and channel access. MU schemes and SU schemes may be used for the data transmission over a given link independently to the multiple links. In particular, one of the MU schemes adopted in the IEEE/802.11ax-2021 standard may be implemented independently on each link.

Therefore, through multi-link aggregation, MPDUs that belong to the same TID can be transmitted on multiple links; their transmission is generally independent, in terms of timing and resource allocation, from one link to another(s). By default, all TIDs are mapped to all setup links for both UL and DL directions, a non-AP MLD can use any link within the set of enabled links to transmit frames carrying MSDUs or A-MSDUs with that TID.

Optionally, the MSDUs may be subject to a TID-to-link mapping. The TID-To-Link Mapping may be negotiated in between MLD entities during Link setup, and intends to indicate on which links MSDUs belonging to each TID can be exchanged. As a result, the TID-To-Link Mapping is the management feature in charge of piloting the access for data to Links 15-x, 15-y and 15-z in both UL and DL directions.

To meet low latency requirements in EHT as well as to increase efficiency of the UL MU operation, the Stream Classification Service (SCS) mechanism, originally defined in the IEEE/802.11aa standard, has been proposed to be used as a light-weight mechanism for a non-AP station to inform the AP of its QoS requirements, especially for low-latency traffics.

Low latency reliable services, LLRS, are services provided to a higher layer traffic stream that prioritize and deliver MSDUs within a worst-case latency budget with a given reliability/packet delivery ratio (PDR) and low jitter. Traffic that may be concerned by LLRS includes latency sensitive data, i.e. data from applications such as gaming, media streaming, augmented reality, virtual reality, and so on.

Originally, the SCS mechanism allowed the establishment of traffic streams with higher layer signaling of packet drop eligibility (e.g. allowed some packets in the traffic stream to be tagged as drop eligible) and allowed classification of traffic streams into an access category, using TCLAS processing.

The typical scenario of using SCS consisted in working with local traffic streams, wherein subsequently the SCS mechanism provided signalling for selecting some packets (drop-eligible ones) in the traffic streams with a view of discarding them in case of insufficient channel capacity. In short, the SCS mechanism aims to differentiate between separate traffic streams within the same access category or the same TID, and covers the need to allow for the graceful degradation of the traffic stream in case of bandwidth shortage.

The SCS mechanism has been recently modified to be adapted to the ML context. As shown in the D1.3 standard, a Multi-Link SCS procedure is now provided in the context of robust audio-video streaming.

Like in IEEE 802.11aa, the Multi-Link SCS procedure provides SCS Request frames, either to create/add, modify, or delete a SCS stream, and corresponding SCS Response frames. A SCS stream is defined in those SCS Request frames through a so-called SCS descriptor, and is identified by a SCS identifier, SCSID, in the SCS Response frames.

The SCS descriptor has been modified for the EHT standard as shown in FIG. 4a, to include a Traffic Specification, called QoS Characteristics Element 425, as a set of QoS characteristics: QoS parameters describing the traffic characteristics and QoS expectations of traffic flows that belong to the SCS stream described by the SCS descriptor.

The other fields in the SCS descriptor 400 keep their meanings.

Each traffic stream is assigned an ID by an affiliated non-AP station requesting classification. This ID, named SCSID, is unique across the non-AP MLD, because it is managed at MLD level.

The Request Type field 421 is a number to identify the type of SCS request: Add, Remove, or Change.

The optional Intra-Access Category Priority element 422 provides information to the AP MLD on the relative priorities of the SCS traffic streams within an AC. It corresponds to the optional introduction of two alternate queues proposed by the IEEE 802.11aa standard, compared to the four primary queues of EDCA.

The TCLAS Elements 423 and the TCLAS Processing Element 424, if present, describe the criteria for traffic classification the non-AP MLD requests the AP MLD to apply to identify the data or MSDUs forming the corresponding SCS stream. These elements are mandatory for downlink direction (traffic from the AP MLD to the non-AP MLD), but are forbidden in the current standard for other directions (UL or for direct link).

The recently introduced QoS Characteristics Element field 425 contains zero or one QoS Characteristics element to describe the traffic characteristics and QoS expectations of traffic flows that belong to this SCS traffic stream.

The recently introduced SCS mechanism introduced for the EHT standard remains a light-weight protocol for a non-AP MLD to inform the AP MLD of its QoS requirements.

As shown in FIG. 4b, the setup of an SCS stream uses the MAC subLayer Management Entity (MLME) primitives of the non-AP MLD (generated by the local Station Management Entity (SME) according to the 802.11 management architecture), resulting in a set of two network frames:
An SCS Request frame 430 sent by a non-AP STA affiliated with the non-AP MLD towards the corresponding affiliated AP of the AP MLD. The SCS Request frame contains a QoS Characteristics element 425 in which the Direction subfield is set to uplink or downlink or bidirectional link. The SCS Request frame is interpreted as a request for creating (or deleting or changing according to the value of Request Type Element 421) a traffic stream that applies at the MLD level for low latency traffic.
Upon receipt of the SCS Request frame 430 from the associated non-AP STA, the affiliated AP responds with a corresponding SCS Response frame 431, the format of which is much more simpler (SCSID plus a status field).

Although the SCS mechanism allows a SCS stream to be defined for low latency traffic, the mechanism is still deficient to properly handle such latency sensitive streams.

In particular, the SCS mechanism defines SCS streams within ACs and within TIDs, while each AC and even each TID may include more than one local, low latency or not, traffic stream (local applications). Hence, this is not an easy task to manage separately a SCS stream from the other streams of the same AC or same TID.

Also, the SCS mechanism is focused on DL traffic and does not address devices that are latency sensitive data producers (e.g. Head Mounted Display). With the current SCS mechanism, the AP MLD classifies MSDUs incoming from the Distribution System (generally the Internet) based on SCS parameters (TCLAS) provided by the non-AP MLD through the SCS Request frames. For uplink traffic (i.e. MSDUs generated by the non-AP MLD), no TCLASS is allowed to be specified, meaning the AP has no information useful for scheduling latency sensitive data pending in the non-AP MLD's transmit queue (AC). Such scheduling for medium access may include trigger-based UL transmission or TWT Service Periods.

Co-pending application GB 2108299.5 provides an extended usage of the SCSID identifier, in both Trigger frame (UL MU operation) and Service Periods (e.g. target wake time periods, TWT) dedicated to low latency flow delivery. TWT agreements for low latency service periods refer to restricted-TWT (rTWT) in the D1.3 standard, which are mainly Broadcast TWT specifying characteristics of an SCS stream. These mechanisms allow the AP MLD to allocate specific resources to one or more SCS traffic streams previously declared in SCS Request frames (based on the received SCS Descriptor). Such discrimination of the low latency traffic using the SCS mechanism offers better efficiency and finer granularity for the latency sensitive traffics.

Nevertheless, the proposed mechanism requires additional behavior at the non-AP MLD to finely separate low latency MSDUs (belonging to the SCS stream) from other MSDUs within the transmit queue of the AC. Indeed, for the above trigger-based or TWT Service Period opportunities, there is a need to retrieve and select only the low latency MSDUs (corresponding to a traffic identified by an SCSID) and not the other MSDUs of the same AC or same TID that are not low latency. Marking of the MSDUs in the transmit queue is an option.

Also, such selection of a sub-part (SCS stream) of the MSDUs having the same TID may have strong impact on device implementations. For instance, the continuity of the sequence numbers in the MSDUs can be lost because some MSDUs take precedence in transportation. This may impact the block-acknowledgment mechanism (to acknowledge the MSDUs), hence increase the risks of head-of-line blocking for LL data.

In other words, the SCSID-based low latency traffic differentiation requires high-end devices, which are not often available for non-AP MLDs, contrary to AP MLDs. Indeed, non-AP MLDs are often low-end devices, which are then limited to consider TID-based low latency traffic differentiation which is unsatisfactory (less efficient, transmission of low latency MSDUs together with not-low latency MSDUs belonging to the same TID).

The present invention addresses this issue to allow low-end EHT non-AP MLDs to manage low latency traffic using the SCS mechanism. An AP MLD is preferably considered as a high-end device. This is to improve the communication (e.g. triggered-based or TWT Service Period opportunities to transmit as scheduled by the AP MLD) of low latency traffic with the AP MLD based on TIDs.

The proposal has two folds.

Firstly, a local traffic stream is identified using a Stream Classification Service, SCS. A Stream Classification Service adapted to multi-link devices is used enabling each non-AP MLD to report the specification of given (low latency) traffic stream awaiting to be transmitted together with a first TID, selected locally and reserved by the non-AP MLD for said given traffic stream. The non-AP MLD still expects this TID to be scheduled by the AP MLD (through triggered-based mechanisms or TWT Service Periods) for transmission of its low latency SCS stream.

Such TID intended to be used for the local SCS stream is referred below to as “target TID”. Of course, when several local SCS streams are managed according to the invention, multiple target TIDs are used, one per each local SCS stream for example. Also in some embodiments, plural SCS streams may be assigned to the same target TID to implement the invention; hence, the AP MLD will schedule transmission for those plural SCS streams when using the target TID in the schedule triggering.

Secondly, the local SCS traffic stream is mapped onto said target TID. However, as, due to conventional mechanisms, the target TID may already be used because it was previously mapped with a first user priority, it is provided that the first user priority, UP, is also mapped onto another TID. The second mapping ensures the target TID is fully reserved and dedicated to the local SCS traffic stream.

The first UP is referred below to as the “impacted UP”, while the other TID is referred to as “fallback TID”.

The non-AP MLD may implement one additional queue in one or more ACs (at most 4) to have a pair of primary and alternate queues respectively identified by the two TIDs of the AC. Thanks to the mapping, one of the two queue (the one having the target TID) becomes reserved for the SCS traffic stream (with SCSID) as soon as the corresponding SCS request (add) is accepted. The MSDUs having the impacted UP, already stored in the alternative queue (because of the initial mapping, they are associated with the target TID) may be transferred to the other queue of the same AC (hence the one having the fallback TID), in order to keep its QoS.

For ease of explanation, it is considered the description below that the queue dedicated to a SCS stream according to the invention is an alternate queue identified by the target TID. On the other hand, the primary queue of the AC is used as a fallback queue for the MSDUs initially stored in the alternate queue when a new SCS stream is added. The primary queue is thus identified by the fallback TID. Of course, other implementations (e.g. reversing the role of the alternate and primary queues may be contemplated).

The AP MLD may become aware of the new local SCS traffic stream when receiving, from the non-AP MLD, a SCS request frame adding the local SCS traffic. Although the target TID may be predefined (e.g. a single TID is available at each MLD or several TIDs are available that are selected in a predefined order), the SCS request frame may include an SCS identifier of the local traffic stream and signals the target TID onto which the local traffic stream is mapped and/or the impacted UP with which the target TID was previously mapped. Indeed, as explained below, the target TID and the impacted UP are closely linked due to the initial UP-to-TID mapping: one of them is enough to infer the other one. In the description below, the target TID is used and exchanged as a main parameter to determine an AC, a primary queue or an alternate queue. The use and exchanged of the impacted UP can also be implemented as an alternative.

Receiving such SCS description, the AP MLD is aware of the target TID identifying the SCS stream and is then able to correctly schedule subsequent UL transmissions (either in SU or MU mode or in a restricted period) for the low latency SCS stream so defined using such target TID.

By allowing the non-AP MLD to specify a unique TID (target TID) for the transmission of each discriminated low latency traffic (SCS stream), the chances to be scheduled by the AP MLD for the low latency traffic streams and to have them respecting the low latency constraints are improved.

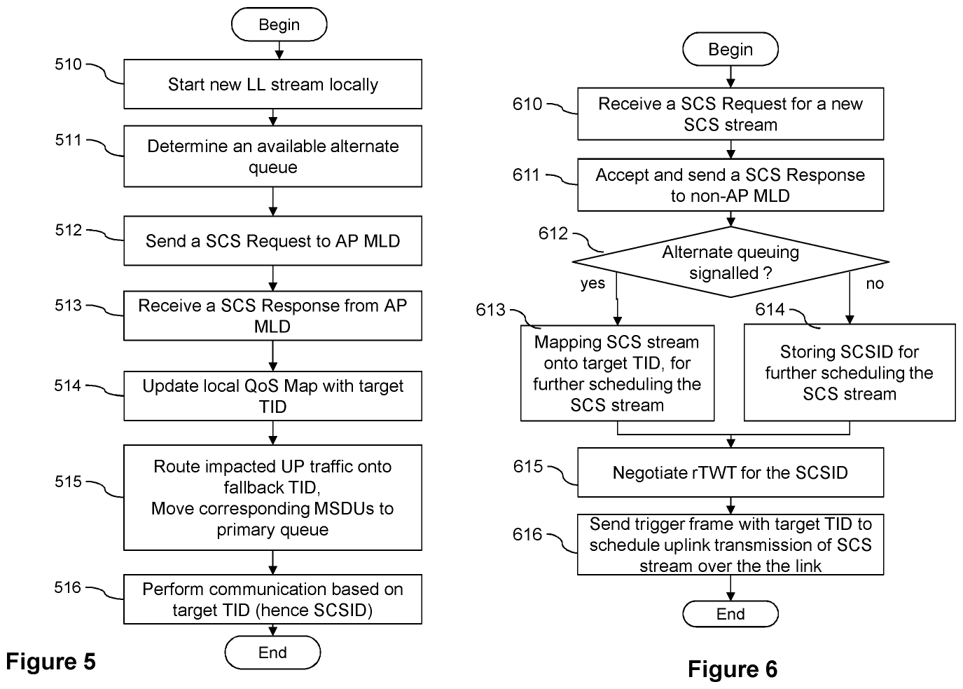

FIGS. 5 and 6 illustrate, using flowcharts, exemplary steps of a communication method at non-AP and AP MLDs, respectively, according to embodiments of the invention. The two MLDs negotiate a SCS stream for a traffic stream locally generated at the non-AP MLD, which SCS stream is then mapped alone on the target TID to offer to the AP MLD a capacity of scheduling it without other traffic streams. As mentioned previously, this approach may advantageously be used to schedule low latency traffic.

In these flowcharts, it is considered the non-AP MLD has previously registered to the AP MLD. Hence, multiple links are active between their respective affiliated non-AP stations and APs. One of these links may be selected by the MLD initiating the process (here mainly the non-AP MLD), to convey the management frames used to negotiate the SCS stream.

Furthermore, the non-AP MLD may have declared its capability to implement the present invention. This may be done within the Capabilities Element exchanged during registration. For example, the affiliated non-AP station sets a new control variable as extended capability: dot11AlternateLLQoSMappingActivated. When dot11AlternateLLQoSMappingActivated is set to true (i.e. implementation of the invention), dot11SCSActivated (already defined in D1.3) is true and dot11AlternateEDCAActivated (also already defined) is true.

As shown in FIG. 5, a triggering event is detected at step 510 in the non-AP MLD that identifies a local traffic stream to be handled as a SCS stream according to the invention. Such local traffic stream generated by the upper layers is for instance low latency traffic.

For example, a MLME-SCS.request primitive is received locally from an upper application (SME of an affiliated non-AP station) that requests the associated MLME to transmit an SCS Request frame to the corresponding affiliated AP. The set of parameters necessary to identify this SCS stream are contained in the primitive. Hence, they can be locally stored so that the further mapping onto the target TID could be conducted for that specific stream. For example, these parameters may be stored in the format of TCLAS Elements 423, TCLAS Processing Element 424 and QoS Characteristics Element 425.

Thanks to step 510, a local traffic stream is identified using a Stream Classification Service, SCS.

Next, at step 511, the non-AP MLD determines one available priority queue that can be allocated to the incoming requested SCS stream. A queue is said to be available when it is eligible and it is not yet associated or allocated to an SCS stream.

Only one or some queues from amongst the AC queues may be eligible for an association with an SCS stream, meaning that only a subset of the AC queues can be used. For example, there is a unique eligible queue amongst the ACs. Alternatively, one queue per one or more (possibly each) ACs may be eligible.

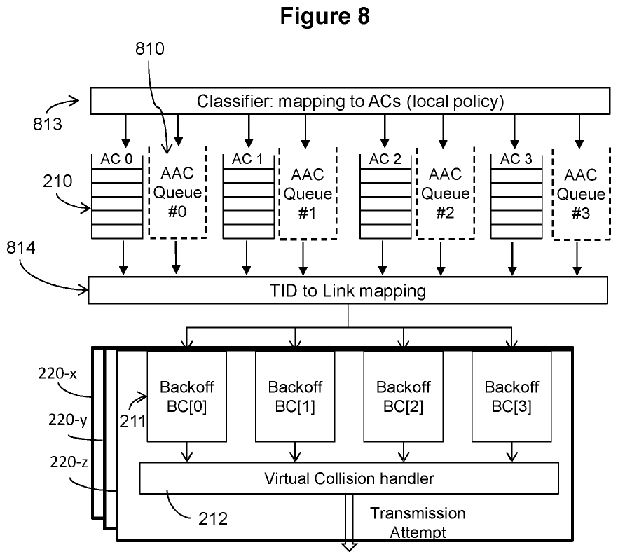

Preferably, only the alternate queues in the ACs are eligible queues. For example, FIG. 2b shows two eligible queues AAC2 and AAC3 that may or may not be available at a time point. In the example of FIG. 8 described below, there are four eligible queues: each alternate (AAC) queue in each AC. Of course, three alternate queues may be also contemplated (one per each of three ACs).

In a variant, the primary queues only are eligible.

An eligible queue is not currently yet associated or allocated to an SCS stream when it is mapped with a user priority UP and not an SCS stream. Plural eligible queues may be available at the same time, while plural eligible queues may be currently allocated to an SCS stream according to the invention.

For example, in conventional QoS mapping, each UP 0-7 are mapped onto each TID 0-7 respectively. When an alternate queue is implemented in an AC, the two TIDs of the AC are used to identify separately each of the primary and alternate queues. Each queue is thus identified by at least one TID and corresponds to at least one UP in the by-default mapping. With this mapping, no alternate queue is yet associated or allocated to an SCS stream. Modifications of this mapping (as described below) may lead to have alternate queues not available.

Once the non-AP MLD has identified the queue or queues eligible and available for an association with an SCS stream, the non-AP MLD selects one of them. Its identifying TID is the target TID.

If a single queue is available, it is selected and its identifying TID is retrieved. Optionally, the selection is made only if the queue belongs to the same AC (i.e. data type) as the local traffic stream. The belonging may be evaluated based on the DSCP applied to the local traffic stream. For example, if the local traffic stream is video, only the alternate queue in the AC_VI can be selected if available.

If plural queues are available, a random selection can be conducted. Alternatively, a predefined order can be followed (e.g. along the priorities of the corresponding ACs or along the numbering order of the queues). Alternatively, the selection is preferably made with an available queue belonging to the same AC as the local traffic stream; and if not another available queue is selected.

If no queue is available (all the eligible queues are currently used for SCS streams), the process ends, meaning that the new SCS stream cannot processed according to the invention due to a too high number of SCS streams.

Alternatively, in some embodiments, a queue is said to be available when it is eligible and it is not yet associated to an SCS stream or yet associated to one or more SCS streams (up to a certain number) that share common QoS characteristics with the new SCS stream being processed. This allows several SCS streams that share common QoS characteristics (as example having common service intervals) to be assigned, and then to transit over, the same eligible queue.

At the end of step 511, a target queue with its corresponding target TID has been identified and selected. Due to the original (in fact current) UP-to-TID mapping, the impacted UP (often equal to target TID but not necessarily) is also obtained.

Next, at step 512, the non-AP MLD builds an SCS Request frame 430 to negotiate with the AP MLD the addition of the local traffic stream as an SCS stream. Still at step 512, the SCS Request frame is sent by the affiliated non-AP station to the AP MLD.

The SCS Request frame 430 includes an SCS Descriptor element having the Request Type field set to “Add” or “Change”, containing a SCS classification (made of the TCLAS Elements), containing an SCS identifier (SCSID) of the local traffic stream, and signaling the target TID onto which the local traffic stream will be mapped and/or the impacted UP with which the target TID was previously mapped. The target TID will be assigned to each MSDU that matches the SCS classification, as long as the SCS stream has not been terminated.

The SCS descriptor also informs of the transmission direction of the SCS stream (typically uplink in the present case) in a dedicated Direction subfield.

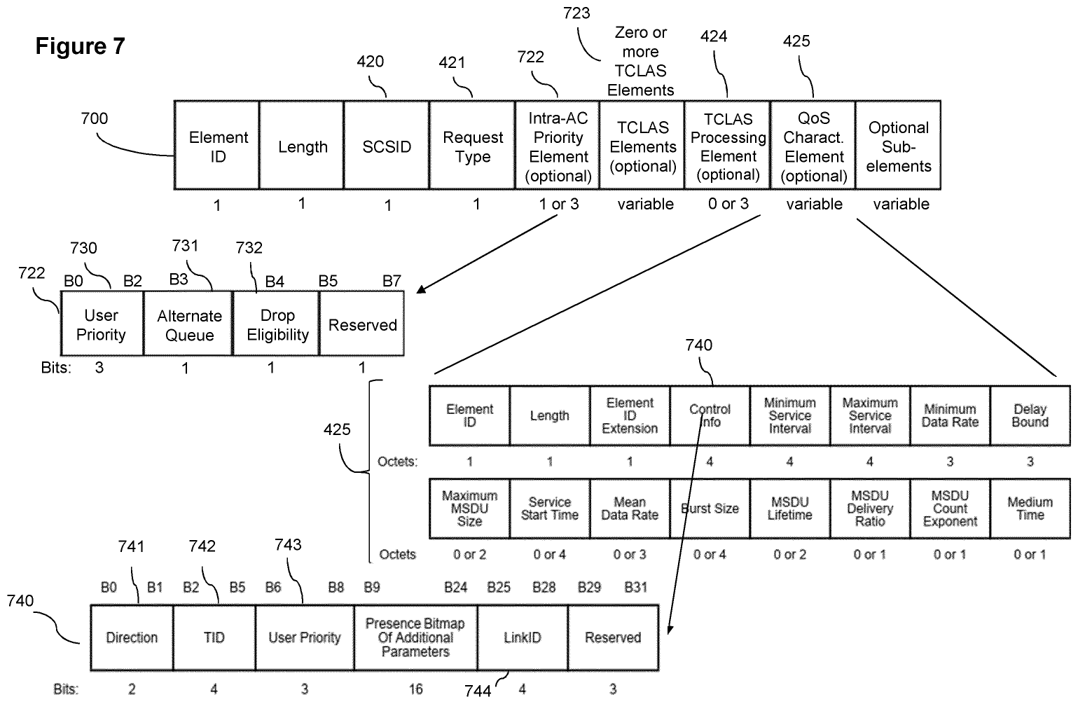

In more details, FIG. 7 illustrates an exemplary modified SCS Descriptor that may be used in a ML SCS service according to embodiments of the invention.

As shown in this embodiment, an Intra-Access Category Priority element 422 (in FIG. 4a) is made mandatory inside the SCS descriptor of the SCS Request frame 430. This mandatory element is referenced Intra-Access Category Priority element 722. It is present when Request Type field 421 is equal to “Add”, “Change” or “Remove” (whereas usually only present for to “Add” or “Change requests).

The other fields in the SCS Descriptor keep their legacy format as defined in the D1.3 standard. However, the meaning and use of some of these other fields are slightly adapted for the present invention.

When dot11AlternateLLQoSMappingActivated (in the declaration of capabilities) is true, the Intra-Access Category Priority element 722 is defined as follows:
The User Priority subfield 730 indicates the impacted UP for MSDUs or A-MSDUs of the SCS stream to which this Intra-Access Category Priority element 722 relates in the context of the SCS Descriptor. Indirectly (due to the current UP-to-TID mapping), this target UP identifies a target AC. It is recalled that the impacted UP and the target TID are linked by the current QoS Mapping.
The Alternate Queue subfield 731 indicates the intended primary or alternate EDCA queue to use for the local SCS stream when dot11AlternateLLQoSMappingActivated is true. When the Alternate Queue subfield is equal to 0, the primary EDCA queue of the target AC is used for queueing MSDUs of the local traffic stream identified by the SCS Descriptor. When the Alternate Queue subfield is equal to 1, the alternate EDCA queue of the target AC is used for such queueing.

Preferably, Alternate Queue subfield=0 may mean that the local SCS stream is declared according to the D1.3 approach, i.e. as an additional stream within the existing TID (i.e. possibly mixes with other streams). Alternate Queue subfield=1 may mean an activation of the present invention: the target TID is fully dedicated to this single SCS stream (or multiple SCS streams sharing same QoS Characterics). In that case, when dot11AlternateLLQoSMappingActivated is true, the Intra-Access Category Priority element 722 contains an Alternate Queue subfield equal to 1 when Request Type field is equal to “Add”, “Change”. This is to favour the use of the alternate queues for the local SCS streams.

Optionally, activation of the present invention is also explicitly dependent of one bit of the Reserved subfield (B5 to B7) set to 1: therefore if dot11AlternateLLQoSMappingActivated is true and this additional bit is true, for matching MSDUs that are part of a SCS stream, the Alternate Queue subfield of the Intra-Access Category Priority element is used to select whether the mechanism of the invention (alternate AC queue reserved for the local LL) is used for these MSDUs. When the designed one bit of the Reserved subfield (B5 to B7) set to 0, then the Alternate Queue value 731 follows the legacy 802.11 approach, meaning it indicates the intended primary or alternate EDCA queue is used for MSDUs identified by User Priority subfield 730.

Hence, when Alternate Queue subfield 731 of Intra-Access Category Priority element 722 is set to 1 in a SCS Request frame adding or changing a SCS stream, it indicates that the non-AP MLD intends to reserve an AC queue (with the target TID) for the local LL traffic specified inside the SCS Descriptor.

The Intra-Access Category Priority element 722 may contain an Alternate Queue subfield equal to 0 when Request Type field 421 is equal to “Change” or “Remove”, to deactivate the present invention.

Note that the non-AP MLD may indicate the reservation of the TID for local SCS stream is over when Alternate Queue subfield equal to 0 (typically for “Remove” type request). The mechanisms of the invention are then deactivated for the SCS stream: the mapping of the SCS stream onto the target TID is ended and the impacted UP are mapped back onto the target TID once released.

In embodiments, Alternate Queue subfield equal to 1 (typically for “Remove” type request) may signal that the mapping of the SCS stream onto the target TID is indeed stopped, but that the initial mapping between the impacted UP and the released target TID is not restored. The released target TID is kept available for a next SCS stream.

The Drop Eligibility subfield 732 is not used in the present invention.

TCLAS Elements field 423 contains zero or more TCLAS elements to specify how incoming MSDUs are classified as part of this SCS stream.

TCLAS Processing Element field 424 is present when more than one TCLAS element is present in the TCLAS Elements field and contains a TCLAS Processing element that defines how the multiple TCLAS elements are to be processed.

Optional Subelements field contains zero subelements, as no element is defined at the moment.

The TCLAS Elements and the TCLAS Processing Element fields, if present, generally describe the traffic classification the non-AP MLD requests the AP MLD to apply to identify incoming MSDUs of the corresponding stream, before transmitting them to the non-AP MLD with the appropriate TID. Concerning Uplink or Direct-link directions, the incoming data forming the MSDUs come from a higher layer of the non-AP MLD; therefore no classification is mandated to be sent to the AP MLD as it will not use this information.

QoS Characteristics element 425 defines traffic specification for the local SCS stream. It is taken into account by the AP MLD to properly schedule the non-AP MLD to transmit the local SCS stream. As an example, the AP MLD may enable the transmission of frames from the non-AP MLD with an interval that falls between the requested minimum and maximum service intervals and the AP MLD may meet the minimum data rate requested if the Direction subfield of the QoS Characteristics element indicates uplink or direct-link. As shown in the Figure, various fields are provided in QoS Characteristics element 425 that define various QoS transmission parameters for the local SCS stream.

Control Info field 740 within QoS Characteristics element 425 is defined as follows:
Direction subfield 541 specifies the direction of data: Uplink, Downlink, Direct-link. As mentioned above, the invention has high interest in the Uplink direction of the local SCS stream, to allow the AP MLD to schedule the non-AP MLD to transmit this SCS stream (Direct-link direction may also take benefit of the invention, in contrary to Downlink direction where the emitter, the AP, does not require a specific identification for emitting the SCS stream),
TID subfield 742 contains the target TID value of the MSDUs belonging to the local SCS stream (i.e. as described by the SCS Descriptor 700). This is this TID that can be used by the AP MLD to schedule (e.g. polling Buffer status reports, allocating resources in emitted trigger frames) the SCS stream.
User Priority subfield 743 contains the impacted UP (value 0-7),
LinkID subfield 744 may contain the link identifier of the link for which the QoS Characteristics so defined apply, to transmit the local SCS stream.

Other subfields of QoS Characteristics element 425 are of less importance for the present invention; they represent the set of parameters defining the characteristics and QoS expectations for the SCS stream.

In a preferred embodiment, the non-AP MLD sets the User Priority subfield 743 to the same value as the User Priority subfield 730.

Turning now to FIG. 6, the AP MLD receives the multi-link SCS Request frame 430 at step 610.

In response thereto, the AP MLD sends a corresponding SCS Response frame 431 to the non-AP MLD, at step 611. A value of SUCCESS is set in the corresponding Status field of the SCS Status in the SCS Response frame when the AP MLD accepts the ML-SCS Request for the requested SCSID. The Response frame does not include any traffic specification (i.e. QoS Characteristics Element).

The AP MLD next determines (at step 612) whether an update of its QoS mapping with the requesting non-AP MLD is required for the SCS stream indicated in the SCS Request frame 431. This may be done by checking the value of Alternate Queue subfield 731 in Intra-Access Category Priority Element field 722 of SCS descriptor 700.

For example, if Alternate Queue subfield 731 has value 1, it indicates an activation of the invention and that alternate queue of the target AC (identified by the target TID or impacted UP mentioned in the SCS Request frame 430) is to be used for the SCS stream.

In preferred embodiment, this determination 612 is only performed if the non-AP MLD has indicated, during the association procedure, support of the alternate mapping inside its Capabilities (the dot11AlternateLLQoSMappingActivated control variable set to 1). Optionally, this determination is also dependent of one bit (B5 to B7) of the Reserved subfield in Intra-Access Category Priority Element field 722 of SCS descriptor 700.

In the affirmative of test 612, an update of the QoS mapping for the non-AP MLD is required, where the indicated target TID (subfield 742) is now used for WLAN operations referring to the SCS stream (e.g. obtaining a buffer status, triggering data, scheduling service periods, etc.). This is step 613.

Also, incoming streams having the impacted UP are now routed to the fallback TID, i.e. to the other TID of the same AC as the target TID. An update of the QoS Mapping at the AP MLD can be made in a similar way as described below with reference to steps 514/515 at the non-AP MLD side.

However, considering the AP MLD point of view of QoS mapping, it is up to the AP MLD to consider if it has to store such complete updated mapping per non-AP STA MLD. At least the AP MLD shall keep in memory the allocation of the target TID to the SCS stream (i.e. SCSID), and the mapping of the impacted UP to the fallback TID for each non-AP STA MLD having issued an SCS request.

In the negative of test 612, only a new SCS stream is declared without reserving a TID for it, as proposed in the D1.3 standard. Hence, the AP MLD may consider the indicated SCSID (subfield 420) as the identifier to be used for WLAN operations referring to the SCS stream. This is step 614.

Back to FIG. 5, the SCS Response frame 431 is received by the non-AP MLD at step 513.

If the requested SCS stream is accepted by the AP MLD, it means the non-AP MLD has to process subsequent incoming local MSDUs to determine if they match classification as specified in the SCS Descriptor element to store them in the appropriate queue. To that end, two configuration steps are performed at the non-AP MLD to adjust the local QoS Mapping.

First, at step 514, the non-AP MLD updates the local QoS Mapping to include the local SCS stream with the appropriate TID. In particular, the SCS stream is mapped onto the target TID in the updated QoS mapping. This means for example that the MSDUs of the SCS stream will be routed to the alternate queue of the target AC.

To differentiate the traffic belonging to the latency sensitive SCS stream from the traffic belonging to the non-latency sensitive streams, the non-AP MLD has thus indicated the use of the target TID as identification for the SCS stream corresponding to SCSID value.

Next, at step 515, the non-AP MLD updates the local QoS Mapping to avoid the MSDUs having the impacted UP and being initially mapped to the target TID be still routed to the target TID. This is to avoid mixing the SCS stream with other MSDUs in the alternate queue. The impacted UP is therefore mapped onto the fallback TID (different from the target TID), preferably the TID identifying the primary queue of the same AC as the target TID. This is to route these MSDUs to this primary queue.

In addition, the MSDUs having the impacted UP that are already in the alternate queue identified by the target TID are moved to the primary queue identified by the fallback TID. Preferably, the sequence number of these MSDUs is adapted or updated to the primary queue when moved to that queue. In particular, their sequence numbers are modified to continue the current sequence numbering in the primary queue.

It is to be noted that these MSDUs that have moved can be triggered by the TID corresponding to the primary queue. As the alternate and primary queues share the same backoff engine, the same priority is kept for these MSDUs having moved from the alternate queue to the primary one.

Once the non-AP MLD is configured with the updated QoS mapping at steps 514 and 515, an appropriate inter-queue priority mapping of all incoming local MSDUs is required. This is now explained with reference to FIG. 8 which illustrates an exemplary architectural concept of such inter-queue priority mapping.

In this example, the number of alternate (or AAC) queues is at most 4, and each AAC queue corresponds to a primary queue belonging to the same AC.

Preferably, only one SCS stream is mapped onto each AAC queue. Besides it is not limitative. This ensures the AP MLD only triggers an SCS stream through the use of the target TID identifying the AAC queue.

This design of primary queues 210 and AAC queues 810 is presented as an illustration only. Any implementation of queuing by TID or UP instead of per AC can be envisioned, when the SCS stream is mapped onto such TID or UP according to the teachings of the invention.

QoS classifier 813 (or QoS Mapper) contains a set of parameters necessary to identify various kinds of incoming MSDUs from a higher layer in the non-AP STA that belong to a particular stream. In particular, it is able to identify the SCS stream (or multiple SCS streams) on one hand, but also any other stream having a conventional UP on the other hand.

Implementations of the QoS classifier for maintaining the mapping of QoS streams and flows are out-of-scope of the invention. As an example, the QoS Classifier 813 may consider using a local TCLAS element to contain the set of parameters necessary to identify incoming MSDUs (this is the definition for each SCS stream) and using a QoS mapping based on the UP of MSDUs, or a particular differentiated services code point (DSCP) for a given service.

QoS classifier 813 obtains the by-default QoS mapping that is distributed by the AP MLD during association with its BSS (as illustrated with QoS Map Element disclosed in FIG. 3). QoS classifier 813 locally updates the mapping with local modifications according to present invention.

Typically, the QoS mapping is modified to reserve the target TID for the incoming local SCS stream, and the streams belonging to the impacted UP formerly mapped onto this target TID is/are re-mapped towards the fallback TID. The MSDUs having the impacted UP (hence stored in the alternate queue identified by the target TID) are moved to the primary queue.

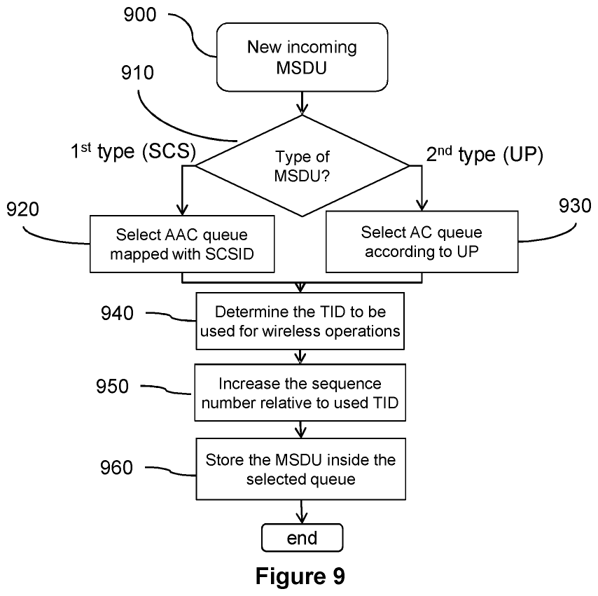

In operation, QoS Classifier 813 handles incoming MSDUs from upper layers as shown in FIG. 9.

When receiving a locally incoming MSDU, QoS classifier 813 analyses the type of frame according to the stored rules (QoS mapping, TCLAS elements stored at the classifier). Some MSDUs are identified as having an UP, while others are identified as belong to a SCS stream (when defined).

If the MSDU belongs to an accepted SCS stream that has a dedicated alternate queue (or target TID as shown in the current QoS mapping), then the classifier executes step 920 for determining the corresponding alternate queue.

Otherwise, the classifier relies on conventional UP classification at step 930 and selects the queue corresponding to the UP of the MSDU, given the current QoS mapping. It is recalled that due to the invention, multiple UPs can be mapped onto a single TID, hence onto a single queue.

The SCS streams that are identified by their SCSID value without having a dedicated queue/TID, are processed through this step, using the UP associated with the SCS stream specified in field 743.

At step 940, the classifier identifies the TID corresponding to the selected queue. This is the TID be used over the air for incoming MSDUs. Thanks to the invention, the target TID is advantageously used to refer to the local SCS stream.

The sequence numbering of the identified TID is increased at step 950 and inserted in the MSDU in the Sequence Number field of this MAC frame.

Note that possibly the MSDU could be previously inserted in an aggregated-MSDU (A-MSDU), or the MSDU could be a management MPDU (MMPDU). Each MSDU, A-MSDU, or MMPDU transmitted by a STA is assigned a sequence number according to the determined TID, and the sequence remains constant in all retransmissions of an MSDU, MMPDU, or fragment thereof.

For a local SCS stream according to the invention, as the target TID is fully dedicated to the SCS stream only, the MSDUs are associated with sequence numbers in sequence that keep information regarding their order.

Next at step 960, the incoming MSDU is stored in the selected queue, either alternate queue 810 or primary queue 210, which is associated with a respective AC for medium access.

Back to FIGS. 5 and 6, based on the above update of the QoS Mapping, the non-AP MLD is ready for communications at step 516 based on TIDs, in particular based on the target TID to trigger transmission of the local SCS stream.

On its side (FIG. 6), the AP MLD configured after step 613 or 614 is also ready to perform communication (steps 616, 617) with the non-AP MLD, in particular based on the target TID dedicated to the SCS stream.

As an example, the affiliated STA of the non-AP MLD starts a TWT negotiation with the AP MLD, namely a restricted TWT (rTWT) negotiation as it concerns LL traffics. A restricted TWT agreement concerning the target TID (and thus the SCS Stream identified with SCSID) may be established using the same procedure used to set up a broadcast TWT agreement. Note that individual TWT agreement is also possible.

The AP MLD accepts (steps 615) the TWT agreement with the STA and confirms the acceptance in a TWT response sent to the non-AP MLD. The AP MLD also includes a broadcast TWT element in the Beacon frame its sends. Therefore, a non-AP MLD can obtain TWT parameter values for the requested SCS stream from the most recently received TWT element carried in a Beacon frames, so that the non-AP MLD can be awaken when TWT service Periods will occur.

The AP MLD may then schedule (step 616) an uplink transmission of MSDUs of the SCS stream from the non-AP MLD by issuing a Trigger frame (e.g. during a rTWT SP). According to embodiments, the Trigger frame contains at least one User Info field addressed to the non-AP MLD and that triggers PPDUs related to the SCSID by specifying the target TID value (742). The trigger frame may in a variant be used without rTWT negotiation (step 615).

When the non-AP MLD is scheduled with the target TID through one of its affiliated STAs, this affiliated STA is in charge of selecting the alternate queue identified by the target TID (that is to say MSDUs in that queue belonging to the SCS traffic stream identified by SCSID) and in charge of forming a TB PPDU with the retrieved MSDUs as a response to the TF.

Preferably, only MSDUs related to the alternate queue identified by the target TID are allowed to be part of the TB PPDU. Optionally, if there is room, some MSDUs belonging to the primary queue of the same AC may be also included in the TB PPDU.

It may be noted that by dedicating the target TID to the SCS stream, sequence numbering and then a link mapping for the target TID is applied only for the SCS stream. Therefore, the block acknowledgment scheme or policy, usually defined at a TID level, is here dedicated to the SCS stream alone (identified by the target TID), hence there is no hole in sequence numbers.

This is an important difference compared to the known technics wherein a TID is composed of various subparts: e.g. low-latency traffic stream belonging to an SCSID and other traffic stream(s) sharing the same UP. Therefore, sequence numbering is common to all the streams of the TID and the block-ack mechanism often suffers from head-of-line blocking for the SCS stream (LL data) when a subpart of the TID (non-LL data MSDUs) is not triggered for transmission.

The mapping of the SCS stream onto the target TID is usually temporary because the SCS stream ends at some time (e.g. the high-layer application ends). Upon detecting a termination event (e.g. MLME-SCS.request primitive), the non-AP MLD may send a SCS Request frame 430 (Request Type=Remove) including the SCSID to terminate the SCS stream. The AP MLD replies with a SCS Response frame 431 accepting the termination. The response includes the SCSID and a value “Terminate” or SUCCESS in the Status field of an SCS Status.

In this case, both the non-AP MLD and AP MLD cease to apply the classifying rules related to this SCSID. The target TID is therefore released by unmapping the SCS stream from this target TID.

Two options may be envisioned regarding the MSDUs having the impacted UP (hence originally mapped onto the target, now released, TID).

In embodiments, no mapping back is made for the impacted UP onto the target TID. This is to keep the alternate queue and target TID for another SCS stream. For example, the non-AP MLD may know that a new SCS stream is coming that will require a dedicated TID. In that case, the absence of mapping back of the impacted UP is signalled by the non-AP MLD in the removing SCS Request frame 430, for instance by setting its Alternate Queue subfield 731 to 0.

In other embodiments, the impacted target UP is mapped back onto the target TID. This is to restore the initial QoS mapping. The latter is updated accordingly. The MSDUs having the impacted UP that are currently stored in the primary queue are then moved to the alternate queue corresponding to the target TID. The sequence numbers of these MSDUs as well as the other MSDUs staying in the primary queue (identified by the fallback TID) are adjusted to ensure continuity in the sequence numbering within each TID.

The non-AP MLD may therefore choose between the two options by signalling its choice in the SCS Request frame. In other words, the removing SCS request frame 430 may signal whether the impacted UP is to be mapped back onto the target TID or not. For example, such signaling is conveyed in an Alternate Queue field of an Intra-AC Priority Element of an SCS descriptor according to IEEE P802.11be/D1.3 within the removing SCS request frame.

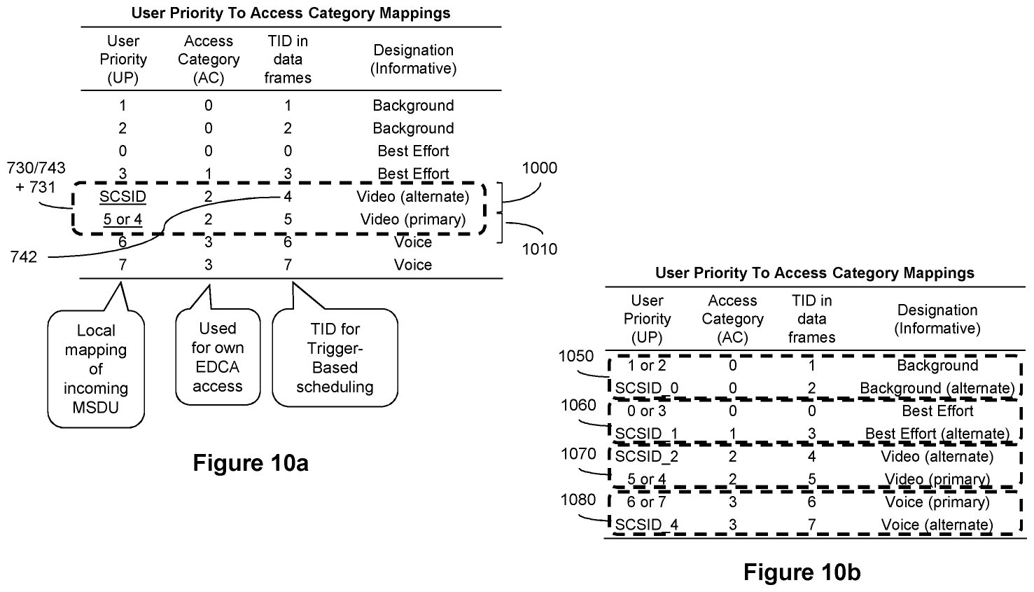

FIG. 10a illustrates an exemplary QoS Mapping when implementing the invention.

It shows an example of mapping between eight priorities of traffic class when one SCS stream has been requested by a non-AP STA according to the embodiments of the invention. This local table has a maximum of 8 rows (as in FIG. 2c), wherein some UP classification(s) corresponding to high layer MSDU may be routed to a distinct priority row in favour of new incoming SCS streams.

In this example, the non-AP MLD has negotiated an SCS stream with a given SCSID value with the AP. This SCS stream is a video stream, hence it is allocated to the alternate video queue. This is shown in row 1000 where the SCSID is associated with target TID=4 identifying the alternate queue of the video AC. The impacted UP is 4, which is therefore mapped onto the primary queue of the video AC. This means the higher layer MSDUs having the impacted UP are now routed to the primary queue of the same AC. This is shown in row 1010, where now both UP=4 and UP=5 feed the primary queue identified with TID=5.

In the SCS Request frame 430 adding the SCS stream (sent at step 512), the Intra-Access Category Priority element 722 contains a User Priority field 730 set to value of the impacted UP, here 4, along with an Alternate Queue subfield value set to 1. This indicates row 1000 is reserved for the incoming SCS stream as identified by SCSID value.

In addition, in the Control Info field 740, the User Priority subfield 743 takes same value 4 as 730, and TID subfield 742 indicates the target TID value (here 4 also) to be used per 802.11 networking operations.

Preferably, alternate queues in the ACs are those identified by TID values 2, 3, 4, 7, and correspond to the same AC priority. The alternate queues values 4, 7 corresponds to those of 802.11aa (with were defined for other usage, not for an SCSID according to the invention). The alternate queue values 2, 3 are implemented in a preferred embodiment so as to obtain a total of four alternate queues. Of course, other variations may be contemplated regarding the number and location of the primary/alternate queues.

FIG. 10b shows the configuration of eight queues with TID values 2, 3, 4, 7 identifying the alternate queues. In this example, four SCS streams are mapped onto the four alternate queues. This is the maximum number of SCS streams that can be mapped in an independent manner, to keep a primary queue in each AC. This ensures keeping compliance with the EDCA medium access rules that are based on four AC queues.

This number of four SCS streams is sufficient in a number of situations, and complies with typical scenario of low latency devices (e.g. an Head-Mounted Display may necessitate several flows, such as for sound and right/left eyes).

A backoff expiring for a given AC aims to trigger either one or both UP and SCS attached to the AC backoff. Typically, as illustrated with row 1050, backoff for AC_0 that expires on a given link allows data units from UP 1+2 and/or SCSID_0 to be transmitted. Similarly, an expiry of the backoff for AC_2 allows data units from UP 4+5 and/or SCSID_2 to be transmitted (see row 1070).

It shall be noted that a backoff expiring on one link is still subject to the TID-to-Link mapping. However, as one TID (e.g. 2, 3, 4, 7) is reserved for an SCS stream, the TID-to-Link mapping (entity 814) may be updated, such that a different link mapping policy is applied in between the non-AP STA MLD and the AP MLD. This allows to allocate distinct Links for SCS stream(s) compared to the legacy UP flows.

Such a possibility could be supported by using the LinkID subfield 744, which thus can be considered as a first (also can be called anchor) link for transportation of the SCS stream. Other additional links (if any) could be negotiated with existing TID-to-Link mapping negotiation mechanism.

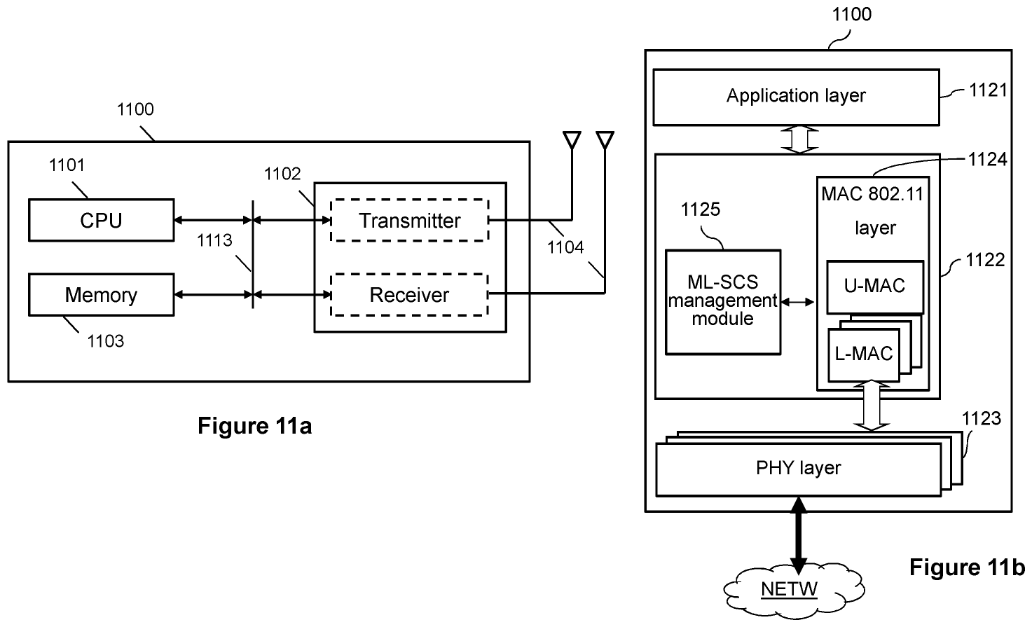

FIG. 11a schematically illustrates a communication device 1100, either a non-AP MLD, embedding a plurality of non-AP stations 110, or an AP MLD, embedding a plurality of APs 100, of a radio network NETW, configured to implement at least one embodiment of the present invention. The communication device 1100 may preferably be a device such as a micro-computer, a workstation or a light portable device. The communication device 1100 comprises a communication bus 1113 to which there are preferably connected:
a central processing unit 1101, such as a processor, denoted CPU;
a memory 1103 for storing an executable code of methods or steps of the methods according to embodiments of the invention as well as the registers adapted to record variables and parameters necessary for implementing the methods; and
at least one communication interface 1102 connected to a wireless communication network, for example a communication network according to one of the IEEE 802.11 family of standards, via transmitting and receiving antennas 1104.

Preferably the communication bus provides communication and interoperability between the various elements included in the communication device 1100 or connected to it. The representation of the bus is not limiting and in particular the central processing unit is operable to communicate instructions to any element of the communication device 1100 directly or by means of another element of the communication device 1100.

The executable code may be stored in a memory that may either be read only, a hard disk or on a removable digital medium such as for example a disk. According to an optional variant, the executable code of the programs can be received by means of the communication network, via the interface 1102, in order to be stored in the memory of the communication device 1100 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 11b is a block diagram schematically illustrating the architecture of the communication device 1100, adapted to carry out, at least partially, the invention. As illustrated, device 1100 comprises a physical (PHY) layer block 1123, a MAC layer block 1122, and an application layer block 1121.

The PHY layer block 1123 (here a multiple of 802.11 standardized PHY layer modules) has the task of formatting, modulating on or demodulating from any 20 MHz channel or the composite channel, and thus sending or receiving frames over the radio medium NETW, such as 802.11 frames, for instance medium access trigger frames to reserve a transmission slot, MAC data and management frames based on a 20 MHz width to interact with legacy 802.11 stations, as well as of MAC data frames of OFDMA type having smaller width than 20 MHz legacy (typically 2 or 5 MHz) to/from that radio medium.

The MAC layer block or controller 1122 preferably comprises a MLE MAC 802.11 layer 1124 implementing conventional 802.11 MAC operations, and additional block 1125 for carrying out, at least partially, embodiments of the invention. The MAC layer block 1222 may optionally be implemented in software, which software is loaded into RAM 1003 and executed by CPU 1001. The MLE MAC 802.11 layer 1124 may implement an Upper-MAC stack 230 along with a series of Lower-MAC modules 220-x/z as introduced in FIG. 2a.

Preferably, the additional block 1125, referred to as Multi-Link Stream Classification Service management module for performing low-latency service over multi-link communications, implements part of embodiments of the invention (either from station, non-AP MLD, perspective or from AP, AP MLD, perspective). This block performs the operations of FIGS. 5, 6, 9 depending on the role of the communication device 1100, non-AP or AP MLD. This block contains the enhanced QoS classifier 813 and the TID-to-Link mapping entity 814.

MAC 802.11-layer 1124 and Multi-Link Stream Classification Service management 1125 interact one with the other in order to establish and process accurately communications over OFDMA RU in between multiple non-AP MLD stations according to embodiments of the invention.

On top of the FIG. 11b, application layer block 1121 runs an application that generates and receives data packets, for example data packets such as a video stream. Application layer block 1121 represents all the stack layers above MAC layer according to ISO standardization.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular, the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network, comprising at a non-access point, AP, multi-link device, MLD:
performing communication with an AP MLD based on traffic identifiers, TIDs,
the method at the non-AP MLD further comprising:
identifying a local traffic stream using a Stream Classification Service, SCS, mapping the local traffic stream onto a target TID previously mapped with an impacted user priority and mapping the impacted user priority, UP, onto a fallback TID.

2. The method of claim 1, further comprising, at the non-AP MLD, sending, to the AP MLD, a Stream Classification Service, SCS, request frame adding the local traffic stream.

3. A communication method in a wireless network, comprising at an access point, AP, multi-link device, MLD:
performing communication with one or more non-AP MLDs based on traffic identifiers, TIDs,
the method at the AP MLD further comprising:
receiving, from a non-AP MLD, a Stream Classification Service, SCS, request frame adding a traffic stream local to the non-AP MLD,
responsive to the receiving, mapping the local traffic stream onto a target TID previously mapped with an impacted user priority and mapping the impacted user priority, UP, onto a fallback TID.

4. The method of claim 2, wherein the SCS request frame includes an SCS identifier of the local traffic stream and signals the target TID onto which the local traffic stream is mapped and/or the impacted UP with which the target TID was previously mapped.

5. The method of claim 2, wherein the SCS request frame includes a SCS descriptor, wherein the SCS descriptor:
identifies the local traffic stream using a SCS identifier, SCSID,
signals the target TID and/or the impacted UP, and
includes an Alternate Queue field in an Intra-AC Priority Element according to IEEE P802.11 be/D1.3, wherein the Alternate Queue field specifies whether a primary queue or an alternate queue in the same access category is dedicated to store the local traffic stream.

6. The method of claim 5, wherein the access category includes a queue identified by the target TID.

7. The method of claim 5, wherein the target TID is signaled in a TID field provided in a Control Info field of a QoS Characteristics Element according to IEEE P802.11 be/D1.3 within the SCS descriptor, and the impacted UP is signaled in a User Priority field provided in the Alternate Queue field.

8. The method of claim 1, wherein the target TID identifies an alternate queue of a pair of primary and alternate queues forming an 802.11 access category.

9. The method of claim 8, wherein the fallback TID identifies the primary queue.

10. The method of claim 1, wherein mapping the impacted UP to the fallback TID includes moving data having the impacted UP from a queue identified by the target TID to another queue identified by the fallback TID, wherein a sequence number of the data is adapted to the other queue when moved to that other queue.

11. The method of claim 1, further comprises sending, to the AP MLD, a SCS request frame removing the local traffic stream, and unmapping the local traffic stream from the target TID.

12. The method of claim 3, further comprises receiving, from the non-AP MLD, a SCS request frame removing the local traffic stream, and, responsive to the receiving, unmapping the local traffic stream from the target TID.

13. The method of claim 11, further comprising mapping back the impacted UP onto the target TID.

14. The method of claim 11, wherein the removing SCS request frame signals whether the impacted UP is to be mapped back onto the target TID or not, such signaling being conveyed in an Alternate Queue field of an Intra-AC Priority Element of an SCS descriptor according to IEEE P802.11 be/D1.3 within the removing SCS request frame.

15. A communication method in a wireless network, comprising at a non-access point, AP:
sending, to an AP, a Stream Classification Service, SCS, request frame, the SCS request frame containing an Intra-Access Category Priority Element and a QoS characteristics Element,
wherein and a User Priority subfield contained in the QoS characteristics Element is set to a same value of a User Priority subfield contained in the Intra-Access Category Priority Element.

16. A Stream Classification Service, SCS, request frame for communication in a wireless network, the SCS request frame containing an Intra-Access Category Priority Element and a QoS characteristics Element, wherein a User Priority subfield contained in the Intra-Access Category Priority element and a User Priority subfield contained in the QoS characteristics Element are set to a same value.

17. A wireless communication device comprising at least one microprocessor configured for carrying out the steps of the method of claim 1.

18. The wireless communication device of claim 17, further comprising one or more access categories, ACs, having one primary queue and one alternate queue, wherein the target TID onto which the local traffic stream is mapped identifies the alternate queue of an AC, whereas the fallback TID identifies the primary queue of that AC.

19. A non-transitory computer-readable medium storing a program which, when executed by a microprocessor or computer system in a wireless device, causes the wireless device to perform the method of claim 1.
